(19) United States
(12) Patent Application Publication
(10) Pub. No.: US 2026/0080488 A1
(43) Pub. Date: Mar. 19, 2026

(54) LOW-CARBON URBAN LAND LAYOUT OPTIMIZATION SIMULATION METHOD, SYSTEM AND EQUIPMENT

(71) Applicant: Shandong Jianzhu University, Jinan (CN)

(72) Inventors: Youchuan CHEN, Jinan (CN); Wenting DUAN, Jinan (CN); Tianzheng MA, Jinan (CN); Peng LI, Jinan (CN); Yihao CHI, Jinan (CN); Liang CHENG, Jinan (CN); Yongbin YANG, Jinan (CN); Wentao WANG, Jinan (CN); Yiran YAN, Jinan (CN)

(73) Assignee: Shandong Jianzhu University, Jinan (CN)

(21) Appl. No.: 19/216,786

(22) Filed: May 23, 2025

(30) Foreign Application Priority Data
Sep. 19, 2024 (CN) 202411302757.6

(51) Int. Cl. G06Q 50/16; G06F 30/13; G06F 30/20; G06F 111/10; G06F 119/08; G06Q 10/04

(52) U.S. Cl. CPC G06Q 50/165; G06F 30/13; G06F 30/20; G06Q 10/04; G06F 2111/10; G06F 2119/08

(57) ABSTRACT

A low-carbon urban land layout optimization simulation method includes establishing a land layout optimization scheme by determining the objective function and constraint conditions of the adjustable land layout optimization; the objective function includes the first objective function to achieve low-carbon transportation, the second objective function to reduce the urban heat island effect, and the third objective function to control and adjust the carbon cost; the vector plot with internal nested grid points is used as the simulation analysis unit, and the genetic algorithm is used to simulate the land layout optimization scheme. In the simulation process, the simulation analysis unit is used to select, cross, and mutate in the genetic algorithm, and finally, the optimal land layout scheme is selected. The method uses the global and holistic characteristics of a genetic algorithm to screen out the optimal land use layout scheme.

### CROSS REFERENCE TO THE RELATED APPLICATIONS

This application is based upon and claims priority to Chinese Patent Application No. 202411302757.6, filed on Sep. 19, 2024, the entire contents of which are incorporated herein by reference.

### TECHNICAL FIELD

The invention belongs to the field of urban land data processing technology, and especially relates to a low-carbon urban land layout optimization simulation method, system, and equipment.

### BACKGROUND

At present, the vast majority of greenhouse gases in the world are produced in cities, how to build a low-carbon city is a significant problem of the times and a common challenge of the world. Spatial form has a long-term structural impact on the operation of urban production and life, once the urban land layout is formed, it will essentially lock in its spatial structure and traffic structure, which in turn affects carbon emissions in related fields such as urban transportation and life. It can be seen that the use of spatial planning to adjust the layout of urban land to reduce urban structural carbon emissions is an important breakthrough in the field of low-carbon development in the future. Optimizing the overall planning to determine the layout of urban construction land is a key link to ensure the scientific and reasonable preparation of detailed planning. Therefore, it is urgent to research the simulation method of low-carbon oriented urban construction land layout optimization, to provide technical support for the preparation of detailed planning and the construction of low-carbon cities.

In the existing technology, it has become a consensus to prevent the change of the function of urban important plots by screening on adjustable plots, but the screening method of adjustable plots needs to be improved; in the optimization goal setting, it focuses on two aspects of land use carbon emissions and traffic carbon emissions, ignoring the carbon cost caused by the adjustment of land use function; in the selection of analysis units, grid units, and vector plot units are used respectively, however, grid units may lead to excessive computation and land use fragmentation in the simulation process, and vector plot units are difficult to accurately identify neighborhood conditions and control land use structure.

### SUMMARY

In order to solve the above technical problems, the invention proposes a low-carbon urban land layout optimization simulation method, system, and equipment. The optimal land layout scheme is selected by using the global and holistic characteristics of the genetic algorithm.

To achieve the above purpose, the invention adopts the following technical scheme:

A low-carbon urban land layout optimization simulation method, including the following steps:
obtaining urban green space data in current land use data and inverting an urban surface temperature; using the urban green space data and the urban surface temperature to determine a cooling spillover capacity of the urban green space, and establishing a prediction model for the cooling spillover capacity of the urban green space;
establishing a land layout optimization scheme by determining an objective function of an adjustable land layout optimization and setting a constraint of the adjustable land layout optimization; the objective function includes a first objective function to achieve a low-carbon transportation, a second objective function to reduce an urban heat island effect and a third objective function to control and adjust a carbon cost; where calculating the second objective function corresponding to a reduction of the urban heat island effect by using the cooling spillover capacity of the green space;
in a genetic algorithm, using a vector plot with internal nested grid points as a simulation analysis unit to simulate the land layout optimization scheme, in a simulation process, using the simulation analysis unit for selecting, crossing, and mutating in the genetic algorithm, and finally selecting an optimal land layout scheme.

Furthermore, a process of inverting the urban surface temperature includes:
after radiometric calibration and atmospheric correction of a cropped urban remote sensing image, obtaining a vegetation coverage by mixed pixel decomposition;
calculating a surface reflectance by using vegetation coverage; using the surface reflectance to calculate a brightness value of blackbody radiation at a same temperature based on a radiative transfer equation;
using the brightness value of blackbody radiation at the same temperature, calculating a surface temperature by Planck's law.

Furthermore, the process of using the urban green space data and the urban surface temperature to determine the cooling spillover capacity of the urban green space includes:
dividing an area to be studied into evenly distributed grid points according to a preset size as a basic research unit, adding urban surface temperature data and land use attribute data to the grid points;
calculating a difference between the surface temperature of plots around the urban green space and the average surface temperature of the same type of land in the study area, using the difference to represent a cooling spillover intensity of the urban green space to the study area;
using a product of the average cooling spillover intensity of the inland block of the cooling spillover range and the cooling spillover area of the urban green space to characterize the cooling spillover capacity of the urban green space.

Furthermore, the first objective function to achieve low-carbon transportation is:

$${ACC}_{i} = {AccessibilityA}_{i} + {AccessibilityB}_{i} + {AccessibilityG}_{i} + {AccessibilityM}_{i} ; \qquad ( 1 )$$

$${f}_{1} = \frac{{{\sum }_{i}}^{n} {ACC}_{i}}{n} ; \qquad ( 2 )$$

where ƒ₁ denotes an average transportation cost of each residential land; ACCᵢ denotes the transportation cost of the plot i; AccessibilityAᵢ denotes a nearest linear distance from plot i to a surrounding public management and public service land; AccessibilityBᵢ denotes a nearest linear distance from plot i to a commercial land; AccessibilityGᵢ denotes a nearest linear distance from plot i to the urban green space; AccessibilityMᵢ denotes a nearest linear distance from plot i to an industrial land; n denotes the number of plots.

Furthermore, the second objective function to reduce the urban heat island effect is:

$${f}_{2} = \frac{1}{{{\sum }_{j}}^{m} {GSCS}_{j}} ; \qquad ( 3 )$$

where ƒ₂ denotes a second objective function value of the land layout optimization scheme to reduce the urban heat island effect; m denotes a number of urban green spaces; GSCSⱼ denotes the cooling spillover capacity of urban green space j.

Furthermore, the third objective function to control and adjust the carbon cost is:

$$DCE = {k}_{d} \times S \times {FAR}_{d} \qquad ( 4 )$$

$$CCE = {k}_{c} \times S \times {FAR}_{c} \qquad ( 5 )$$

$${f}_{3} = {\sum }_{i}^{Q} {DCE}_{i} + {CCE}_{i} \qquad ( 6 )$$

where [symbol] denotes a number of plots where the land use function changes in the land layout optimization scheme; DCE denotes a carbon emission in an original building demolition stage, CCE denotes a carbon emission in a new building stage, k_{d} denotes a carbon emission coefficient in the original building demolition stage, k_{c} denotes a carbon emission coefficient in the new building stage, S denotes a land area of the plot, FAR_{d} denotes an average plot ratio of an original land function of the plot, FAR_{c} denotes an average plot ratio of a new land function of the plot, ƒ₃ denotes a total carbon emission in a process of function adjustment; DCEᵢ denotes a carbon emission of plot i in the original building demolition stage; CCEᵢ denotes a carbon emission of plot i in the new building stage.

Furthermore, constraints of the adjustable land layout optimization include: land structure constraints, blue-green space bottom line constraints, urban structure and road network constraints, and industrial control line constraints.

Furthermore, the process of simulating the land layout optimization scheme by the genetic algorithm includes:
generating a parent population randomly, after the parent population is generated, calculating a fitness value of each individual according to the objective functions;
after calculating the fitness value of each individual, performing a non-dominated sorting, selection, crossover, and mutation simulation of an initial population to generate an offspring population;
merging the parent population and the offspring population into a next parent population, and then performing an iterative operation until a number of iterations reach a set value of the model;
normalizing objective function values of each optimization scheme in an output optimization solution set, and then assigning weights of different optimization objectives, using a weighted sum method to calculate a final target score of each optimization scheme, and selecting the optimal land layout scheme by comparing the final scores.

The invention also proposes a low-carbon urban land layout optimization simulation system, including a preprocessing module, a scheme establishment module, and a simulation optimization module;
the preprocessing module is used to obtain the urban green space data in the current land use data and invert the urban surface temperature; the urban green space data and urban surface temperature are used to determine the cooling spillover capacity of urban green space, and the prediction model of the cooling spillover capacity of the urban green space is established;
the scheme establishment module is used to establish the land layout optimization scheme by determining the objective function of the adjustable land layout optimization and setting the constraints of the adjustable land layout optimization; the objective function includes the first objective function to achieve the low-carbon transportation, the second objective function to reduce the urban heat island effect and the third objective function to control and adjust the carbon cost, where the second objective function corresponding to the reduction of urban heat island effect is calculated by using the cooling spillover capacity of the green space;
the simulation optimization module is used to simulate the land layout optimization scheme by using the vector plot with internal nested grid points as the simulation analysis unit in the genetic algorithm, in the simulation process, the simulation analysis unit for selecting, crossing, and mutating in the genetic algorithm, and finally the optimal land layout scheme is selected.

The invention also proposes low-carbon urban land layout optimization simulation equipment, including a memory, a processor, and a computer program stored on the memory and running on the processor, when the processor executes the program, the low-carbon urban land layout optimization simulation method can be realized.

The effect provided in the invention content is only the effect of the embodiment, not all the effects of the invention, one of the above technical solutions has the following advantages or beneficial effects:

The invention proposes a low-carbon urban land layout optimization simulation method, system, and equipment, which belongs to the field of urban land data processing technology. The method includes the following steps: obtaining the urban green space data in the current land use data and inverting the urban surface temperature; using the urban green space data and the urban surface temperature to determine the cooling spillover capacity of the urban green space, and establishing the prediction model for the cooling spillover capacity of the urban green space; establishing a land layout optimization scheme by determining an objective function of the adjustable land layout optimization and setting the constraint of the adjustable land layout optimization; the objective function includes the first objective function to achieve the low-carbon transportation, the second objective function to reduce the urban heat island effect and the third objective function to control and adjust the carbon cost; where calculating the second objective function corresponding to the reduction of the urban heat island effect by using the cooling spillover capacity of the green space; in the genetic algorithm, using the vector plot with internal nested grid points as the simulation analysis unit to simulate the land layout optimization scheme, in a simulation process, using the simulation analysis unit for selecting, crossing and mutating in the genetic algorithm, and finally selecting the optimal land layout scheme. Based on a low-carbon urban land layout optimization simulation method, a low-carbon urban land layout optimization simulation system and equipment are also proposed. The invention helps solve the problem that the land use layout process relies too much on the personal experience of the planner, which makes it difficult to accurately quantify multiple planning objectives and obtain an accurate plan, the optimal land use layout plan is selected by using the global and holistic characteristics of genetic algorithm.

### BRIEF DESCRIPTION OF THE DRAWINGS

FIG. 1 is a flow chart of a low-carbon urban land layout optimization simulation method proposed in Embodiment 1 of the invention;

FIG. 2 is a flow chart of the construction method of the prediction model of the cooling spillover capacity of the urban green space proposed in Embodiment 1 of the invention;

FIG. 3 is a flow chart of the adjustable plot screening method in the urban land layout simulation proposed in Embodiment 1 of the invention;

FIG. 4 is a flow chart of the NSGA-II algorithm in the low-carbon urban land layout optimization simulation method proposed in Embodiment 1 of the invention;

FIG. 5 is a schematic diagram of the work division of the vector block unit of the inner nested grid proposed in Embodiment 1 of the invention;

FIG. 6 is a schematic diagram of the low-carbon urban land layout optimization simulation system proposed in Embodiment 2 of the invention;

FIG. 7 is a schematic diagram of the low-carbon urban land layout optimization simulation equipment proposed in Embodiment 3 of the invention.

### DETAILED DESCRIPTION OF THE EMBODIMENTS

In order to clearly explain the technical characteristics of this scheme, the following is a detailed description of the invention through the specific implementation method and drawings. The following disclosure provides many different embodiments or examples to implement the different structures of the invention. In order to simplify the disclosure of the invention, the parts and settings of a specific example are described below. In addition, the invention can repeat reference numbers and/or letters in different examples. This repetition is for simplification and clarity and does not in itself indicate the relationship between the various embodiments and/or settings discussed. It should be noted that the parts shown in the drawings are not necessarily drawn in proportion. The invention omits the description of the well-known components and processing technology and process to avoid unnecessary restrictions on the invention.

### Embodiment 1

Embodiment 1 of the invention proposed a low-carbon urban land layout optimization simulation method, which was used to solve the problem that the land use layout process in the existing technology relies too much on the personal experience of the planner, which made it difficult to accurately quantify multiple planning objectives and obtain accurate solutions.

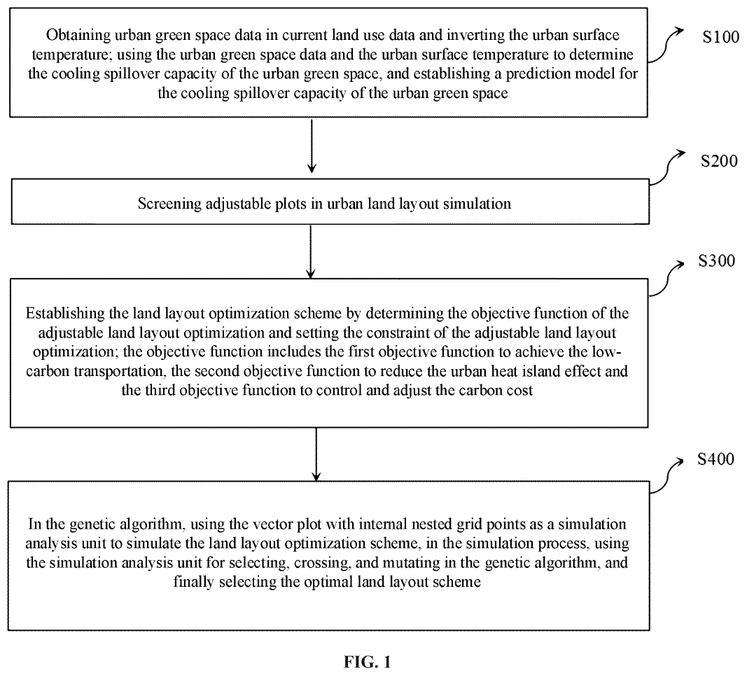

FIG. 1 is a flow chart of a low-carbon urban land layout optimization simulation method proposed in Embodiment 1 of the invention.

In S100, the urban green space data in current land use data were obtained and the urban surface temperature was inverted; the urban green space data and the urban surface temperature were used to determine the cooling spillover capacity of the urban green space, and a prediction model for the cooling spillover capacity of the urban green space was established;

This application was based on the ArcGis platform to extract the urban green space in the current land survey data. The attribute table of the current urban land use data was opened on the ArcGis platform and the ‘Select by Attribute’ command was executed to filter the urban green space and export the SHP file.

The urban surface temperature was inverted based on the ENVI platform. The specific operation process was as follows:
Radiometric calibration and atmospheric correction were performed on the cropped Landsat-8 remote sensing images;
the vegetation coverage (FVC) obtained by mixed pixel decomposition (MPD) was determined;
surface reflectance (LSE) was calculated by using vegetation coverage;
the surface reflectance is used to calculate the brightness value of blackbody radiation at the same temperature based on the radiative transfer equation;
the surface temperature was calculated according to Planck's law.

The analysis tools such as overlay and buffer in ArcGis were used, the cooling spillover capacity of the urban green space was calculated, and the specific operation process included:
The fishing net tool in GIS was used to divide the study area into 50 m×50 m evenly distributed grid points as the basic research unit;
the surface temperature data and land attribute data were added to the grid point by using the value extraction to point tool;
the difference between the surface temperature of the land around the urban green space and the average surface temperature of the same type of land in the study area was calculated by using the multi-ring buffer tool, and the difference was used to represent the cooling spillover intensity of the urban green space to the point;
the product of the average cooling spillover intensity of the inland block and the cooling spillover area of the urban green space was used to characterize the cooling spillover capacity of the urban green space.

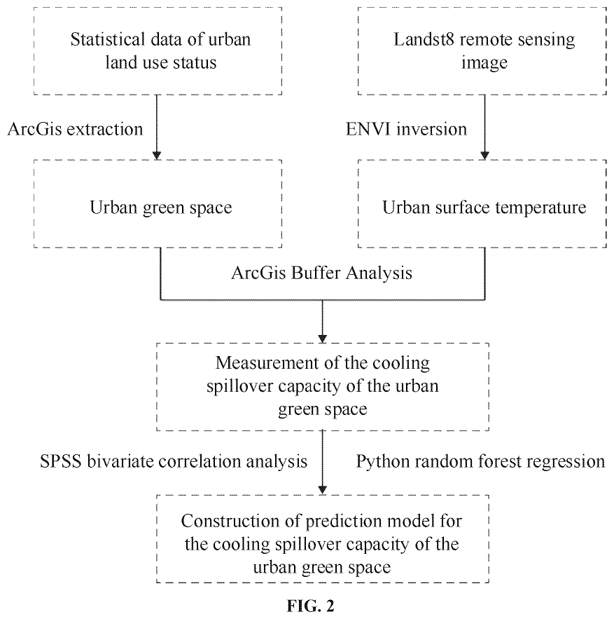

FIG. 2 is the flow chart of the construction method of the prediction model of the cooling spillover capacity of the urban green space proposed in Embodiment 1 of the invention; based on the correlation analysis, the influencing factors were preliminarily screened, and the random forest algorithm was used to construct the prediction model of the cooling spillover capacity of the urban green space. The specific operation was as follows:

The bivariate correlation analysis was used in SPSS to screen the influencing factors from the variables such as plot perimeter, plot perimeter area ratio, plot shape index, plot surrounding openness, and the relationship between plot and summer dominant wind direction.

The RandomForestRegressor in the sklearning module was called in the JupyterNotebook, and the regression model was constructed with the cooling spillover ability as the explained variable and the selected influencing factors as the explanatory variables.

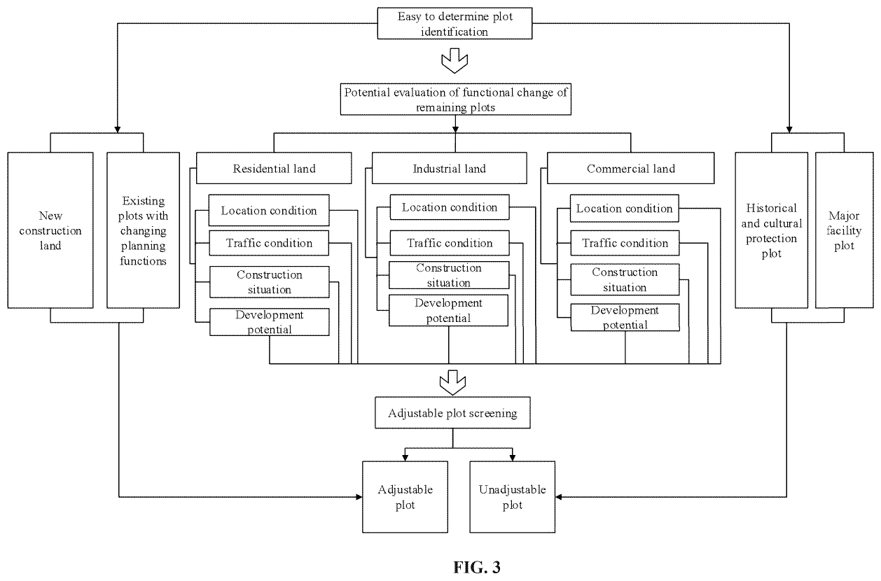

In S200, the adjustable plots in the simulation of urban land use layout were selected. FIG. 3 is the flow chart of the adjustable plot screening method in the urban land layout simulation proposed in Embodiment 1 of the invention;

in the ArcGis platform, the core protection area of historical and cultural blocks in the urban area, the inland blocks, the areas where immovable cultural relics are located, and the cultural relics protection units at all levels, as well as other public service facilities land, transportation facilities land, infrastructure land, and current public green space that have a significant impact on the urban spatial structure in other special plans, were classified as functional non-adjustable plots.

The new construction land and the existing construction land with changeable functions were classified as the first batch of adjustable plots.

The evaluation index system of the difficulty of functional adjustment of residential, industrial, and commercial land was constructed from four aspects: current situation basis, location conditions, traffic resources, and development potential. Based on the SPSSPRO platform, the CRITIC-TOPSIS method was used to measure the difficulty of functional adjustment of the remaining plots in the land layout planning and classified by the natural discontinuity point method, the plots with less adjustment difficulty were taken as the second batch of adjustable plots.

In S300, the land layout optimization scheme was established by determining the objective function of the adjustable land layout optimization and setting the constraint of the adjustable land layout optimization; the objective function includes the first objective function to achieve low-carbon transportation, the second objective function to reduce the urban heat island effect and the third objective function to control and adjust the carbon cost;

the sum of the nearest linear distance between residential land and commercial land, industrial land, urban green space, public management, and public service land was used to characterize the transportation cost, and the average transportation cost of each residential land was used to characterize the first objective function of urban low-carbon transportation.

$${ACC}_{i} = {AccessibilityA}_{i} + {AccessibilityB}_{i} + {AccessibilityG}_{i} + {AccessibilityM}_{i} \qquad ( 1 )$$

$${f}_{1} = \frac{{{\sum }_{i}}^{n} {ACC}_{i}}{n} \qquad ( 2 )$$

where ƒ₁ denotes an average transportation cost of each residential land; ACCᵢ denotes the transportation cost of plot i; AccessibilityAᵢ denotes a nearest linear distance from plot i to a surrounding public management and public service land; AccessibilityBᵢ denotes a nearest linear distance from plot i to a commercial land; AccessibilityGᵢ denotes a nearest linear distance from plot i to the urban green space; AccessibilityMᵢ denotes a nearest linear distance from plot i to an industrial land; n denotes the number of plots.

The sum of the cooling spillover capacity of the urban green space was used to characterize the effect of the optimization scheme on reducing the urban heat island effect. In order to ensure the consistency of the value direction of the optimization objective function, the reciprocal of the sum of the cooling spillover capacity of the urban green space is used to characterize the second objective function to reduce the urban heat island effect.

$${f}_{2} = \frac{1}{{{\sum }_{j}}^{m} {GSCS}_{j}} ; \qquad ( 3 )$$

where ƒ₂ denotes the second objective function value of the land layout optimization scheme to reduce the urban heat island effect; m denotes the number of urban green spaces; GSCSⱼ denotes the cooling spillover capacity of urban green space j.

The third objective function value of the control function adjustment carbon cost is characterized by the carbon emission estimation of the upper building in the demolition and reconstruction stage during the land use function conversion process caused by the land use layout adjustment.

$$DCE = {k}_{d} \times S \times {FAR}_{d} \qquad ( 4 )$$

$$CCE = {k}_{c} \times S \times {FAR}_{c} \qquad ( 5 )$$

$${f}_{3} = {\sum }_{i}^{Q} {DCE}_{i} + {CCE}_{i} \qquad ( 6 )$$

where [symbol] denotes a number of plots where the land use function changes in the land layout optimization scheme; DCE denotes a carbon emission in an original building demolition stage, CCE denotes a carbon emission in a new building stage, k_{d} denotes a carbon emission coefficient in the original building demolition stage, k_{c} denotes a carbon emission coefficient in the new building stage, S denotes a land area of the plot, FAR_{d} denotes an average plot ratio of an original land function of the plot, FAR_{c} denotes an average plot ratio of a new land function of the plot, ƒ₃ denotes a total carbon emission in a process of function adjustment; DCEᵢ denotes a carbon emission of plot i in the original building demolition stage; CCEᵢ denotes a carbon emission of plot i in the new building stage.

The constraints of the adjustable land layout optimization include: land structure constraints, blue-green space bottom line constraints, urban structure and road network constraints, and industrial control line constraints.

Constraints of land use structure: The land use structure should reflect the social needs of the construction area of various uses in the city, the imbalance of urban land use structure will adversely affect the development of urban industry, public services, residents' life, and space quality. Therefore, the change of urban land use structure needs to meet the requirements of relevant norms and standards and adapt to the actual development needs of urban functions and industrial structure, and present a stable and dynamic change trend. In view of this, the land use structure constraint is set up to limit the construction land structure of each land use layout scheme to meet the requirements of Urban Land Classification and Planning Construction Land Standard (GB50137-2011).

The bottom line constraint of blue-green space: The urban blue-green space is not only an important place for residents' recreation and leisure, but also provides multiple functions such as ecological services and disaster prevention. Specifically, the urban green public open space can form an urban cold island and reduce the urban heat island effect; adsorption of fine particles, and purification of air; the permeability of the urban underlying surface was changed to alleviate urban waterlogging; the shelter was provided to reduce disaster losses. In the process of land layout optimization, the existing blue-green space should be ensured not to be destroyed and supplemented as much as possible.

Urban structure and road network constraints: Urban spatial structure and road network system were the product of urban historical development and the basic skeleton of the urban material space. Therefore, the urban structure and road network constraints are set to limit the urban functional attributes from being greatly changed during the simulation process, at the same time, the existing urban road network system is retained to minimize the negative impact of the urban land layout optimization on the overall development continuity of the city.

Industrial control line constraints: in order to strengthen and improve the supply management of industrial land in construction land, promote the transformation of industrial land supply from transfer to leasing and transfer, and promote the steady growth of the industrial economy, the industrial land control line was delineated in the territorial space planning. In the optimization of land use layout, industrial control constraints were set to limit the proportion of industrial land outside the industrial control line to no more than 10%.

In S400, in the genetic algorithm, the vector plot with internal nested grid points was used as the simulation analysis unit to simulate the land layout optimization scheme, in the simulation process, the simulation analysis unit was used for selecting, crossing, and mutating in the genetic algorithm, and finally, the optimal land layout scheme was selected.

Firstly, the chromosome was encoded by real number coding, and the urban land layout scheme was converted into a digital chain through the coding process, each number on the digital chain denotes a ‘gene’, and the ‘genes’ are arranged in a spatial order to form a ‘chromosome’.

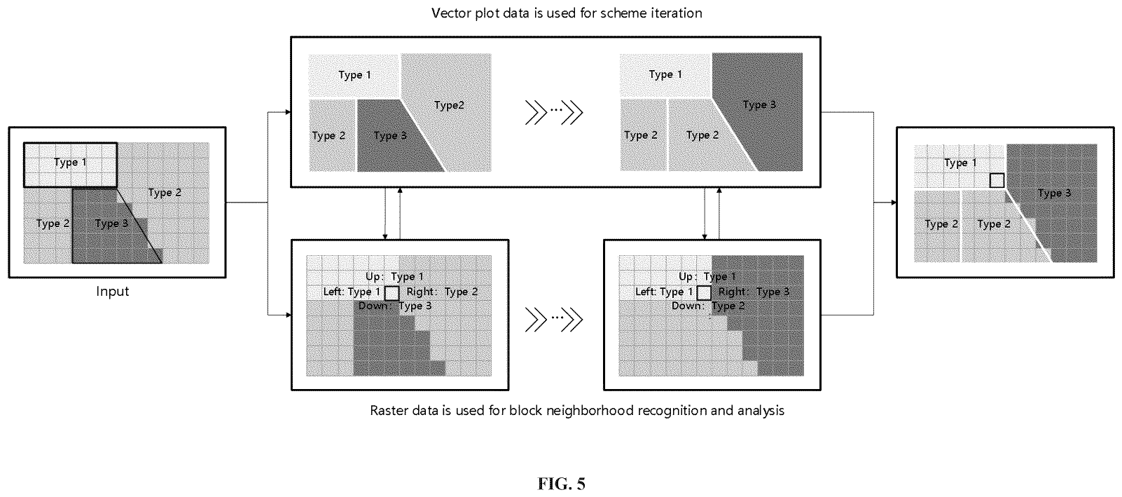

Secondly, in order to improve the problems caused by the optimization simulation of urban land layout using grid unit and vector block unit alone in the existing technology. FIG. 5 is the schematic diagram of the work division of the vector block unit of the inner nested grid proposed in Embodiment 1 of the invention; the advantage of using this nested basic unit is that the optimization program can execute its own operation commands based on the two basic units, and the internal attributes are always unified. For the same land patch, the vector block unit and the grid unit had the same ‘land_id’ information, and the simulation program used this information to identify the corresponding relationship between the vector block unit and the grid unit. In the simulation process, the vector block unit participated in the iterative process of selection, crossover, and mutation as the main body, and had higher search efficiency because its number was significantly less than that of the grid unit; when the program calculated the objective function value of the simulation scheme, the grid unit nested inside the vector plot could be called to participate in the operation to improve the accuracy of its neighborhood analysis.

In the specific operation, the vector plot data were obtained from the urban land layout planning, and the grid array was generated according to the spatial specification of 50 M×50 M by using the fishing net tool in ArcGis. With the help of spatial overlay tools, the raster data was nested in the vector land patch, and the attributes of the vector land patch were given to the raster data nested inside it, thus forming two sets of analysis units that were nested and independent of each other.

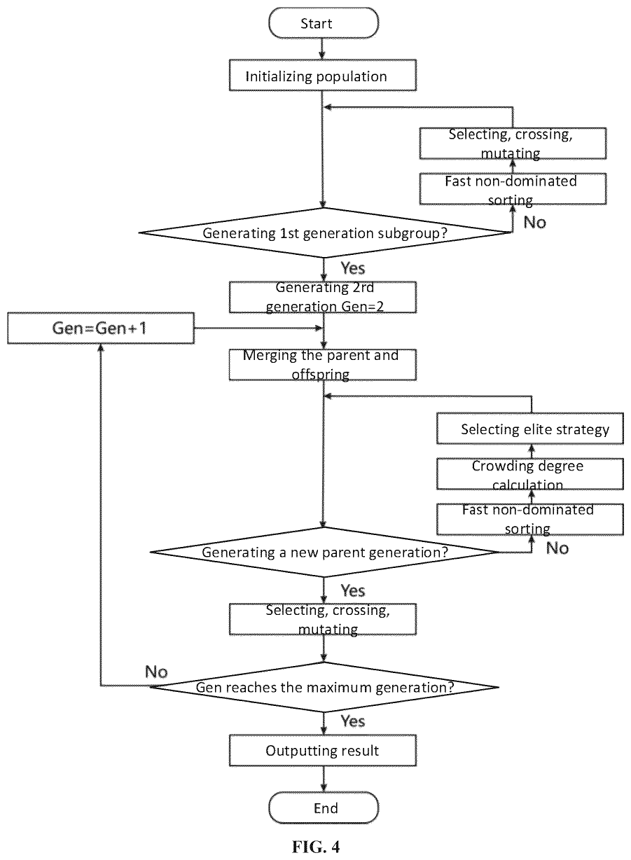

FIG. 4 is a flow chart of the NSGA-II algorithm in the low-carbon urban land layout optimization simulation method proposed in Embodiment 1 of the invention.

After completing the data input and model coding, the parent population was randomly generated, in which the population size N should be set according to the actual needs. After generating the parent population, the fitness value of each individual was calculated according to the set objective function.

Non-dominated sorting and selection, crossover, and mutation simulation were performed on the initial population to generate offspring populations. After calculating the fitness value of each individual, it is necessary to perform non-dominated sorting on the parent population, according to the results of non-dominated sorting, excellent individuals were selected as the parent population for subsequent genetic operations. After the selection operation, crossover and mutation simulations were required to generate the offspring population.

The parent population and the offspring population were merged into a new population, and the new population was subjected to non-significant sorting, crowding distance calculation, and elite strategy to generate a new parent population.

The computer performed iterative operations until the number of iterations reached the model setting value. During each iteration, a batch of new offspring individuals was generated, and the new parent population was generated through non-significant sorting, crowding distance calculation, and elite strategy. When the number of iterations reached the set value, the algorithm stopped the iteration and outputs the solution set of the Pareto optimal solution that satisfies the constraint.

The objective function values of each optimization scheme in the output optimization solution set were normalized, and then the weights were assigned to different optimization objectives, and the weighted summation method was used to calculate the final objective score of each optimization scheme. By comparing the final scores, the optimal land use layout scheme could be selected.

Embodiment 1 of the invention proposes a low-carbon urban land layout optimization simulation method, which helps solve the problem that the land use layout process relies too much on the personal experience of the planner, which makes it difficult to accurately quantify multiple planning objectives and obtain accurate solutions, the optimal land use layout scheme is selected by using the global and holistic characteristics of genetic algorithm.

### Embodiment 2

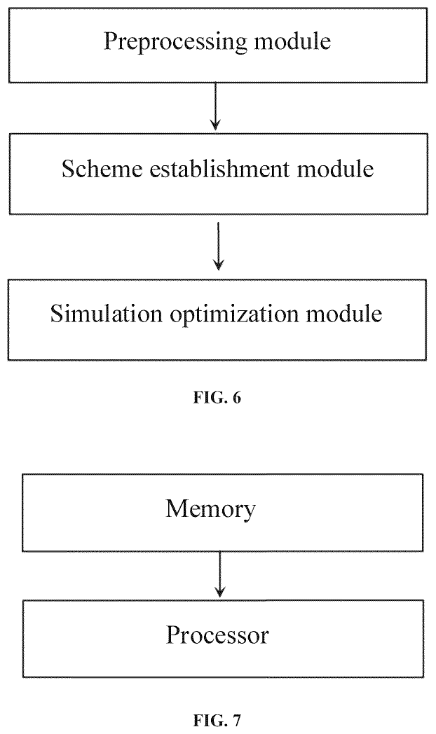

Based on a low-carbon urban land layout optimization simulation method proposed in Embodiment 1 of the invention, a low-carbon urban land layout optimization simulation system is also proposed in Embodiment 2 of the invention. FIG. 6 is a schematic diagram of the low-carbon urban land layout optimization simulation system proposed in Embodiment 2 of the invention. The system includes a preprocessing module, a scheme establishment module, and a simulation optimization module;
the preprocessing module was used to obtain the urban green space data in the current land use data and invert the urban surface temperature; the urban green space data and urban surface temperature were used to determine the cooling spillover capacity of urban green space, and the prediction model of the cooling spillover capacity of the urban green space was established;
the scheme establishment module was used to establish the land layout optimization scheme by determining the objective function of the adjustable land layout optimization and setting the constraints of the adjustable land layout optimization; the objective function included the first objective function to achieve the low-carbon transportation, the second objective function to reduce the urban heat island effect and the third objective function to control and adjust the carbon cost, where the second objective function corresponding to the reduction of urban heat island effect was calculated by using the cooling spillover capacity of the green space;
the simulation optimization module was used to simulate the land layout optimization scheme by using the vector plot with internal nested grid points as the simulation analysis unit in the genetic algorithm, in the simulation process, the simulation analysis unit for selecting, crossing, and mutating in the genetic algorithm, and finally the optimal land layout scheme was selected.

In the preprocessing module, the process of inverting the urban surface temperature included: after radiometric calibration and atmospheric correction of the cropped urban remote sensing image, the vegetation coverage was obtained by mixed pixel decomposition; the surface reflectance was calculated by using the vegetation coverage; the surface reflectance was used to calculate the brightness value of blackbody radiation at the same temperature based on the radiative transfer equation; the surface temperature is calculated by Planck's law and the brightness value of blackbody radiation at the same temperature.

The process of measuring the cooling spillover capacity of urban green space by using the urban green space data and urban surface temperature included: The area to be studied was divided into evenly distributed grid points according to the preset size as the basic research unit; the urban surface temperature data and land use attribute data were added to the grid point; the difference between the surface temperature of the plots around the urban green space and the average surface temperature of the same type of land in the study area was calculated to represent the cooling spillover intensity of the urban green space to the study area. The product of the average cooling spillover intensity of the inland block of the cooling spillover range and the cooling spillover area of the urban green space was used to characterize the cooling spillover capacity of the urban green space.

In the scheme establishment module: the first objective function to achieve low-carbon transportation is:

$${ACC}_{i} = {AccessibilityA}_{i} + {AccessibilityB}_{i} + {AccessibilityG}_{i} + {AccessibilityM}_{i} ; \qquad ( 1 )$$

$${f}_{1} = \frac{{{\sum }_{i}}^{n} {ACC}_{i}}{n} ; \qquad ( 2 )$$

where ƒ₁ denotes an average transportation cost of each residential land; ACCᵢ denotes the transportation cost of plot i. AccessibilityAᵢ denotes a nearest linear distance from plot i to a surrounding public management and public service land; AccessibilityBᵢ denotes a nearest linear distance from plot i to a commercial land; AccessibilityGᵢ denotes a nearest linear distance from plot i to the urban green space; AccessibilityMᵢ denotes a nearest linear distance from plot i to an industrial land; n denotes the number of plots.

The second objective function to reduce the urban heat island effect is:

$${f}_{2} = \frac{1}{{{\sum }_{j}}^{m} {GSCS}_{j}} ; \qquad ( 3 )$$

where ƒ₂ denotes a second objective function value of the land layout optimization scheme to reduce the urban heat island effect; m denotes a number of urban green spaces; GSCSⱼ denotes the cooling spillover capacity of urban green space j.

The third objective function to control and adjust the carbon cost is:

$$DCE = {k}_{d} \times S \times {FAR}_{d} \qquad ( 4 )$$

$$CCE = {k}_{c} \times S \times {FAR}_{c} \qquad ( 5 )$$

$${f}_{3} = {\sum }_{i}^{Q} {DCE}_{i} + {CCE}_{i} \qquad ( 6 )$$

where [symbol] denotes a number of plots where the land use function changes in the land layout optimization scheme; DCE denotes a carbon emission in an original building demolition stage, CCE denotes a carbon emission in a new building stage, k_{d} denotes a carbon emission coefficient in the original building demolition stage, k_{c} denotes a carbon emission coefficient in the new building stage, S denotes a land area of the plot, FAR_{d} denotes an average plot ratio of an original land function of the plot, FAR_{c} denotes an average plot ratio of a new land function of the plot, ƒ₃ denotes a total carbon emission in a process of function adjustment; DCEᵢ denotes a carbon emission of plot i in the original building demolition stage; CCEᵢ denotes a carbon emission of plot i in the new building stage.

The constraints of the adjustable land layout optimization include: land structure constraints, blue-green space bottom line constraints, urban structure and road network constraints, and industrial control line constraints.

In the specific operation, the vector plot data were obtained from the urban land layout planning, and the grid array was generated according to the spatial specification of 50 M×50 M by using the fishing net tool in ArcGis. With the help of spatial overlay tools, the raster data was nested in the vector land patch, and the attributes of the vector land patch were given to the raster data nested inside it, thus forming two sets of analysis units that were nested and independent of each other.

The process of using a genetic algorithm to simulate the land layout optimization scheme included:
the parent population was generated randomly, after the parent population was generated, the fitness value of each individual was calculated according to the objective functions;
after calculating the fitness value of each individual, non-dominated sorting, selection, crossover, and mutation simulation of the initial population were performed to generate an offspring population;
the parent population and the offspring population were merged into a next parent population, and then the iterative operation was performed until the number of iterations reached the set value of the model;
the objective function values of each optimization scheme in an output optimization solution set were normalized, and then the weights of different optimization objectives were assigned, the weighted sum method was used to calculate the final target score of each optimization scheme, and the optimal land layout scheme was selected by comparing the final scores.

Embodiment 2 of the invention proposes a low-carbon urban land layout optimization simulation system, which helps to solve the problem that the land use layout process relies too much on the personal experience of the planner, which makes it difficult to accurately quantify multiple planning objectives and obtain accurate solutions, the genetic algorithm has the global and holistic characteristics to screen out the optimal land use layout scheme.

The description of the relevant part of the low-carbon urban land layout optimization simulation system provided by Embodiment 2 of this application can be seen in the detailed description of the corresponding part of the low-carbon urban land layout optimization simulation method provided by Embodiment 1 of this application, which is not repeated here.

### Embodiment 3

The invention also proposes a low-carbon urban land layout optimization simulation equipment. FIG. 7 is a schematic diagram of the low-carbon urban land layout optimization simulation equipment proposed in Embodiment 3 of the invention, including:
memory, used to store computer programs;
processor, the implementation steps when the processor is used to execute the computer program are as follows:

In S100, the urban green space data in current land use data were obtained and the urban surface temperature was inverted; the urban green space data and the urban surface temperature were used to determine the cooling spillover capacity of the urban green space, and a prediction model for the cooling spillover capacity of the urban green space was established;

In S200, the adjustable plots in the simulation of urban land use layout were selected.

In S300, the land layout optimization scheme was established by determining the objective function of the adjustable land layout optimization and setting the constraint of the adjustable land layout optimization; the objective function includes the first objective function to achieve low-carbon transportation, the second objective function to reduce the urban heat island effect and the third objective function to control and adjust the carbon cost;

In S400, in the genetic algorithm, the vector plot with internal nested grid points was used as the simulation analysis unit to simulate the land layout optimization scheme, in the simulation process, the simulation analysis unit was used for selecting, crossing, and mutating in the genetic algorithm, and finally, the optimal land layout scheme was selected.

Embodiment 3 of the invention proposes a low-carbon urban land layout optimization simulation equipment, which helps to solve the problem that the land use layout process relies too much on the personal experience of the planner, which makes it difficult to accurately quantify multiple planning objectives and obtain accurate solutions. The genetic algorithm has the global and holistic characteristics to screen out the optimal land use layout scheme.

The description of the relevant part of the low-carbon urban land layout optimization simulation equipment provided by Embodiment 3 of this application can be seen in the detailed description of the corresponding part of the low-carbon urban land layout optimization simulation method provided by Embodiment 1 of this application, which will not be repeated here

It is important to note that in this article, relational terms such as first and second are used only to distinguish an entity or operation from another entity or operation, and do not necessarily require or imply that there is any such actual relationship or order between these entities or operations. Moreover, the term ‘include’, ‘comprise’ or any other variant of the term is intended to cover non-exclusive inclusion, so as to include a series of elements inherent in the process, method, item, or device. In the absence of more restrictions, the elements limited by the statement ‘including a . . . ’ do not preclude the existence of other identical elements in the process, method, article, or equipment including the said elements. In addition, the part of the above technical scheme provided in this application embodiment that is consistent with the implementation principle of the corresponding technical scheme in the existing technology is not explained in detail, to avoid excessive elaboration.

Although the specific embodiment of the invention is described in combination with the drawings, it is not a limitation on the scope of protection of the invention. For the technical personnel in the field, based on the above description can also make other different forms of modification or deformation. There is no need and no way to exhaust all the implementation methods here. Based on the technical scheme of the invention, various modifications or deformations that can be made by technicians in this field without paying creative labor are still within the protection range of the invention.

What is claimed is:

1. A low-carbon urban land layout optimization simulation method, comprising following steps:
obtaining urban green space data in current land use data of a urban and inverting an urban surface temperature based on a urban remote sensing image obtained by Landsat-8; using the urban green space data and the urban surface temperature to determine a cooling spillover capacity of an urban green space, and establishing a prediction model for the cooling spillover capacity of the urban green space;
establishing a land layout optimization scheme by determining objective functions of an adjustable land layout optimization and setting constraints of the adjustable land layout optimization, wherein the objective functions comprise a first objective function to achieve a low-carbon transportation, a second objective function to reduce an urban heat island effect and a third objective function to control and adjust a carbon cost; wherein the second objective function corresponding to a reduction of the urban heat island effect is calculated by using the cooling spillover capacity of the urban green space;
wherein the first objective function to achieve the low-carbon transportation is expressed as:
ACCᵢ=AccessibilityAᵢ+AccessibilityBᵢ+AccessibilityGᵢ+AccessibilityMᵢ; (1)
$${f}_{1} = \frac{{{\sum }_{i}}^{n} {ACC}_{i}}{n} ; \qquad ( 2 )$$
wherein ƒ₁ denotes an average transportation cost of each residential land; ACCᵢ denotes a transportation cost of a plot i; AccessibilityAᵢ denotes a nearest linear distance from the plot i to a surrounding public management and public service land; AccessibilityBᵢ denotes a nearest linear distance from the plot i to a commercial land; AccessibilityGᵢ denotes a nearest linear distance from the plot i to the urban green space; AccessibilityMᵢ denotes a nearest linear distance from the plot i to an industrial land; n denotes a number of plots;
the second objective function to reduce the urban heat island effect is expressed as:
$${f}_{2} = \frac{1}{{{\sum }_{j}}^{m} {GSCS}_{j}} ; \qquad ( 3 )$$
wherein ƒ₂ denotes a second objective function value of the land layout optimization scheme to reduce the urban heat island effect; m denotes a number of urban green spaces; GSCSⱼ denotes a cooling spillover capacity of an urban green space j;
the third objective function to control and adjust the carbon cost is expressed as:
$$DCE = {k}_{d} \times S \times {FAR}_{d} \qquad ( 4 )$$
$$CCE = {k}_{c} \times S \times {FAR}_{c} \qquad ( 5 )$$
$${f}_{3} = {\sum }_{i}^{Q} {DCE}_{i} + {CCE}_{i} \qquad ( 6 )$$
wherein [symbol] denotes a number of plots where a land use function changes in the land layout optimization scheme; DCE denotes a carbon emission in an original building demolition stage, CCE denotes a carbon emission in a new building stage, k_{d} denotes a carbon emission coefficient in the original building demolition stage, k_{c} denotes a carbon emission coefficient in the new building stage, S denotes a land area of the plot, FAR_{d} denotes an average plot ratio of an original land function of the plot, FAR_{c} denotes an average plot ratio of a new land function of the plot, ƒ₃ denotes a total carbon emission in a process of function adjustment; DCEᵢ denotes a carbon emission of the plot i in the original building demolition stage; and CCEᵢ denotes a carbon emission of the plot i in the new building stage;
wherein the constraints of the adjustable land layout optimization comprise: land structure constraints, blue-green space bottom line constraints, urban structure and road network constraints, and industrial control line constraints;
in a genetic algorithm, using a vector plot with internal nested grid points as a simulation analysis unit to simulate the land layout optimization scheme, in a simulation process, using the simulation analysis unit for selecting, crossing, and mutating in the genetic algorithm, and finally selecting an optimal land layout scheme from all land layout optimization schemes; adjusting land use layout of the urban based on the optimal land layout scheme;
wherein a process of simulating the land layout optimization scheme by the genetic algorithm comprises:
generating a parent population randomly, and after the parent population is generated, calculating a fitness value of each individual according to the objective functions;
after calculating the fitness value of each individual, performing a non-dominated sorting, selection, crossover, and mutation simulation of an initial population to generate an offspring population;
merging the parent population and the offspring population into a next parent population, and then performing an iterative operation until a number of iterations reach a set value of the model; and
normalizing objective function values of each optimization scheme in an output optimization solution set, then assigning weights of different optimization objectives, using a weighted sum method to calculate a final target score of each optimization scheme, and selecting the optimal land layout scheme by comparing the final scores.

2. The low-carbon urban land layout optimization simulation method according to claim 1, wherein a process of inverting the urban surface temperature comprises:
after radiometric calibration and atmospheric correction of a cropped urban remote sensing image, obtaining a vegetation coverage by mixed pixel decomposition;
calculating a surface reflectance by using the vegetation coverage, and using the surface reflectance to calculate a brightness value of blackbody radiation at a same temperature based on a radiative transfer equation; and
using the brightness value of blackbody radiation at the same temperature, calculating the urban surface temperature by Planck's law.

3. The low-carbon urban land layout optimization simulation method according to claim 1, wherein a process of using the urban green space data and the urban surface temperature to determine the cooling spillover capacity of the urban green space comprises:
dividing an area to be studied into evenly distributed grid points according to a preset size as a basic research unit, adding urban surface temperature data and land use attribute data to the evenly distributed grid points;
calculating a difference between a surface temperature of plots around the urban green space and an average surface temperature of a same type of land in a study area, using the difference to represent a cooling spillover intensity of the urban green space to the study area; and
using a product of an average cooling spillover intensity of an inland block of a cooling spillover range and a cooling spillover area of the urban green space to characterize the cooling spillover capacity of the urban green space.

4. A low-carbon urban land layout optimization simulation system, used to implement the low-carbon urban land layout optimization simulation method according to claim 1, and comprising a preprocessing module, a scheme establishment module, and a simulation optimization module; wherein
the preprocessing module is used to obtain the urban green space data in the current land use data of the urban and invert the urban surface temperature based on the obtained urban remote sensing image; the urban green space data and urban surface temperature are used to determine the cooling spillover capacity of the urban green space, and the prediction model of the cooling spillover capacity of the urban green space is established;
the scheme establishment module is used to establish the land layout optimization scheme by determining the objective functions of the adjustable land layout optimization and setting the constraints of the adjustable land layout optimization; the objective functions comprises the first objective function to achieve the low-carbon transportation, the second objective function to reduce the urban heat island effect and the third objective function to control and adjust the carbon cost, wherein the second objective function corresponding to the reduction of the urban heat island effect is calculated by using the cooling spillover capacity of the urban green space; and
the simulation optimization module is used to simulate the land layout optimization scheme by using the vector plot with the internal nested grid points as the simulation analysis unit in the genetic algorithm, wherein in the simulation process, the simulation analysis unit is used for selecting, crossing, and mutating in the genetic algorithm, finally the optimal land layout scheme is selected from all land layout optimization schemes, and land use layout of the urban is adjusted based on the optimal land layout scheme.

5. A low-carbon urban land layout optimization simulation equipment, comprising a memory, a processor, and a computer program stored on the memory and running on the processor, wherein when the processor executes the program, the low-carbon urban land layout optimization simulation method according to claim 1 is realized.

6. The low-carbon urban land layout optimization simulation system according to claim 4, wherein in the low-carbon urban land layout optimization simulation method, a process of inverting the urban surface temperature comprises:
after radiometric calibration and atmospheric correction of a cropped urban remote sensing image, obtaining a vegetation coverage by mixed pixel decomposition;
calculating a surface reflectance by using the vegetation coverage, and using the surface reflectance to calculate a brightness value of blackbody radiation at a same temperature based on a radiative transfer equation; and
using the brightness value of blackbody radiation at the same temperature, calculating the urban surface temperature by Planck's law.

7. The low-carbon urban land layout optimization simulation system according to claim 4, wherein in the low-carbon urban land layout optimization simulation method, a process of using the urban green space data and the urban surface temperature to determine the cooling spillover capacity of the urban green space comprises:
dividing an area to be studied into evenly distributed grid points according to a preset size as a basic research unit, adding urban surface temperature data and land use attribute data to the evenly distributed grid points;
calculating a difference between a surface temperature of plots around the urban green space and an average surface temperature of a same type of land in a study area, using the difference to represent a cooling spillover intensity of the urban green space to the study area; and
using a product of an average cooling spillover intensity of an inland block of a cooling spillover range and a cooling spillover area of the urban green space to characterize the cooling spillover capacity of the urban green space.

8. The low-carbon urban land layout optimization simulation equipment according to claim 5, wherein in the low-carbon urban land layout optimization simulation method, a process of inverting the urban surface temperature comprises:
after radiometric calibration and atmospheric correction of a cropped urban remote sensing image, obtaining a vegetation coverage by mixed pixel decomposition;
calculating a surface reflectance by using the vegetation coverage, and using the surface reflectance to calculate a brightness value of blackbody radiation at a same temperature based on a radiative transfer equation; and
using the brightness value of blackbody radiation at the same temperature, calculating the urban surface temperature by Planck's law.

9. The low-carbon urban land layout optimization simulation equipment according to claim 5, wherein in the low-carbon urban land layout optimization simulation method, a process of using the urban green space data and the urban surface temperature to determine the cooling spillover capacity of the urban green space comprises:
dividing an area to be studied into evenly distributed grid points according to a preset size as a basic research unit, adding urban surface temperature data and land use attribute data to the evenly distributed grid points;
calculating a difference between a surface temperature of plots around the urban green space and an average surface temperature of a same type of land in a study area, using the difference to represent a cooling spillover intensity of the urban green space to the study area; and
using a product of an average cooling spillover intensity of an inland block of a cooling spillover range and a cooling spillover area of the urban green space to characterize the cooling spillover capacity of the urban green space.
